(19) United States
(12) Patent Application Publication
(10) Pub. No.: US 2007/0169588 A1
(43) Pub. Date: Jul. 26, 2007

(54) Hose clamp

(76) Inventor: Dian-Tai Chen, Tatu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/337,523

(22) Filed: Jan. 24, 2006

(51) Int. Cl. B25B 27/10; B25B 13/06

(52) U.S. Cl. 81/9.3; 81/121.1

(57) ABSTRACT

A hose clamp includes a binding belt, a screw holder provided at a first end of the binding belt, a screw pivotally mounted in the screw holder for moving a second end of the binding belt relative to the first end, the screw having a triangular head and a chamfered edge at an outer side of each of the three equal peripheral walls, and a spanner, which has a socket defining a triangular hole for attaching to the triangular head of the screw for rotating the screw positively.

### BACKGROUND OF THE INVENTION

1. Field of the Invention

The present invention relates to hose clamps and more particularly, to a hose clamp driven by a spanner to fasten a hose to a pipe.

2. Description of the Related Art

FIGS. 1 and 2 show a hose clamp according to the prior art. According to this design, the hose clamp comprises a binding belt 1 for fastening a hose to a pipe, a screw holder 10 fixedly provided at the first end of the binding belt 1 and adapted to receive the second end of the binding belt 1, a screw 11 pivotally mounted in the screw holder 10 and meshed with a part of the second end of the binding belt 1, and a spanner 2 for rotating the screw 11 to move the second end of the binding belt 1 relative to the first end of the binding belt 1. The screw 11 has multilateral head 12. The multilateral head 12 has the peripheral walls respectively sloping in axial direction. The spanner 2 has a socket 3 at one end for turning the screw 11. The socket defines a hexagonal coupling hole 4 attachable to the multilateral head 12 of the screw 11. Each peripheral wall of the hexagonal coupling hole 4 slopes in one direction. This design of hose clamp has drawbacks. Because the multilateral head 12 of the screw 11 has the peripheral walls respectively sloping in axial direction, it is difficult to strip off the screw from the mold during fabrication. High defective rate greatly increases the manufacturing cost. Further, it needs to use a special hydraulic tool to attach the socket of the spanner to the head of the screw. When forcing the socket onto the head of the screw, the socket may break.

### SUMMARY OF THE INVENTION

The present invention has been accomplished under the circumstances in view. According to one aspect of the present invention, the screw that is pivotally mounted in the screw holder has a triangular head that has three smooth peripheral walls of each size, and the socket of the spanner has a triangular hole fitting the triangular head of the screw. According to another aspect of the present invention, the three smooth peripheral walls of the head of the screw each has an outer side chamfered so that the socket can easily be attached to the head of the screw.

### BRIEF DESCRIPTION OF THE DRAWINGS

FIG. 1 is an exploded view of a hose clamp according to the prior art.

FIG. 2 is a schematic sectional view showing the spanner attached to the screw according to the prior art.

FIG. 3 is an exploded view of a hose clamp according to the present invention

FIG. 4 is a schematic sectional view showing the spanner attached to the screw according to the present invention.

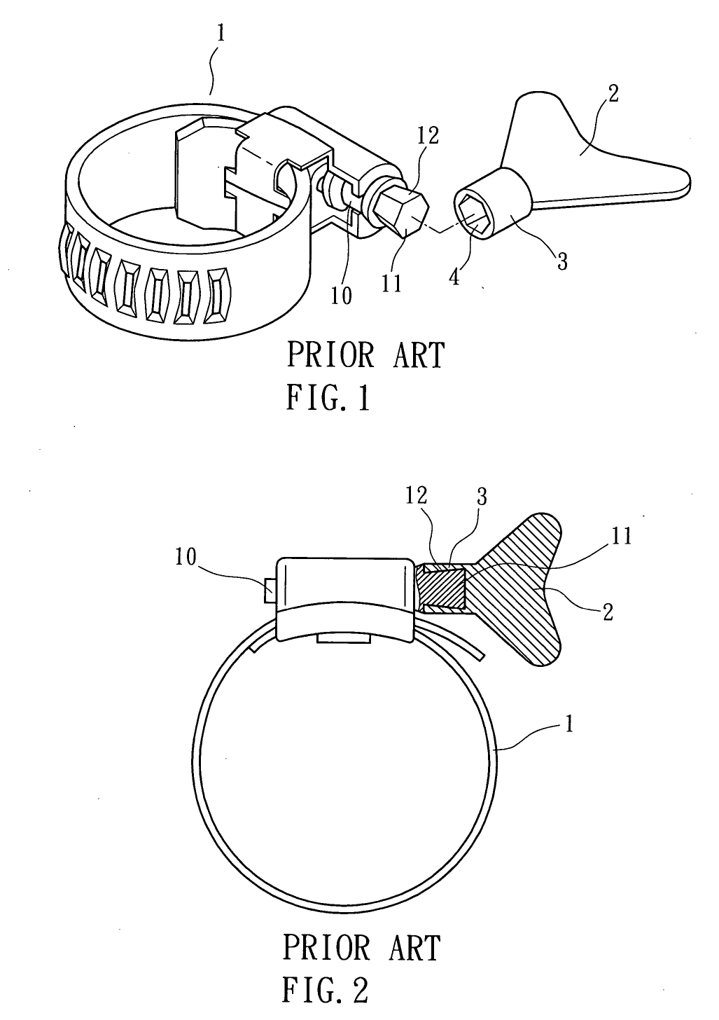

### DETAILED DESCRIPTION OF THE PREFERRED EMBODIMENT

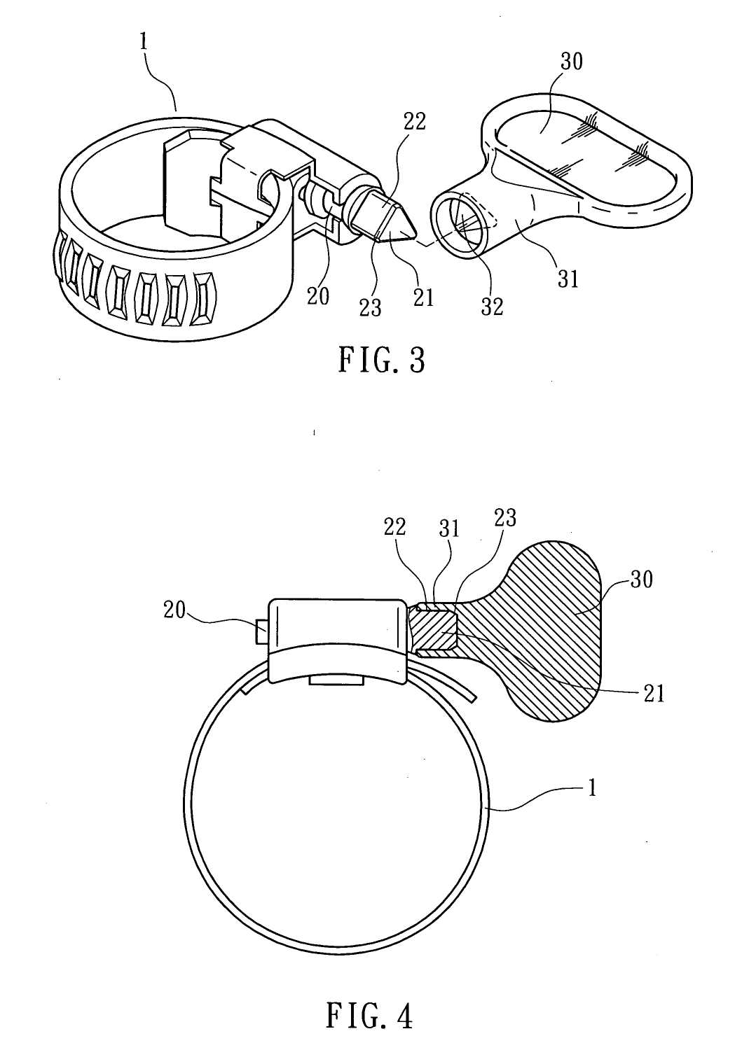

Referring to FIGS. 3 and 4, a hose clamp in accordance with one embodiment of the present invention is shown comprised of a binding belt 1, a screw holder 20 and a spanner 30.

The screw holder 20 is fastened to one end of the binding belt 1 to hold a screw 21 for joining the two ends of the binding belt 1. The screw 21 has a triangular head 22, which has three equal peripheral plain walls 23. Each peripheral plain wall 23 has an outer side chamfered. The spanner 30 has a socket 31 at one end. The socket 31 defines therein a triangular coupling hole 32 fitting the triangular head 22 of the screw 21. By means of the triangular hole 32 of the socket 31, the spanner 30 can easily and positively be attached to the triangular head 22 of the screw 21 and turned to rotate the screw 21 to further pull the two ends of the binding belt 1 forwards/backwards relative to each other so as to further lock the hose clamp to the hose (not shown) or unlock the hose clamp from the hose.

Because the triangular head 22 of the screw 21 has three equal peripheral plain walls 23. The screw 21 can easily be stripped off the mold during fabrication.

Further, because each peripheral plain wall 23 of the triangular head 22 of the screw 21 has the respective outer side chamfered, the triangular hole 32 of the socket 31 of the spanner 30 can easily and smoothly be attached to the triangular head 22 of the screw 21.

Further, when the triangular hole 32 of the socket 31 of the spanner 30 is attached to the triangular head 22 of the screw 21, the spanner 30 can be driven to rotate the screw 21 positively, and the spanner 30 does not slip from the triangular head 22 of the screw 21 during rotation.

A prototype of hose clamp has been constructed with the features of FIGS. 3 and 4. The hose clamp functions smoothly to provide all the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. A hose clamp comprising:
a binding belt for fastening a hose to a pipe, said binding belt having a first end and a second end;
a screw holder fixedly provided at the first end of said binding belt and adapted to receive the second end of said binding belt;
a screw pivotally mounted in said screw holder and meshed with a part of the second end of said binding belt; and
a spanner for rotating said screw to move the second end of said binding belt relative to the first end of said binding belt, said spanner having a socket at one end for turning said screw, said socket defining a coupling hole attachable to said screw;
wherein said screw has a triangular head, said triangular head having three equal peripheral walls extending to a terminal end wall; the coupling hole of said socket of said spanner is a triangular hole fitting the triangular head of said screw, the coupling hole being configured to smoothly and unobstructively receive said triangular head in contiguously conformed manner, said coupling hole defining inner side and end surfaces to respectively maintain flush engagement with said peripheral and terminal end walls of said triangular head received therein.

2. The hose clamp as claimed in claim 1, wherein the three peripheral walls of the triangular head of said screw each has a chamfered edge for guiding the triangular head of said screw into the coupling hole of said socket of said spanner.

3. The hose clamp as claimed in claim 2, wherein said coupling hole of said socket includes a plurality of inner chamfered surfaces extending from said inner side surfaces for engaging said chamfered edges of said triangular head.
